(19) United States
(12) Patent Application Publication
(10) Pub. No.: US 2022/0019803 A1
(43) Pub. Date: Jan. 20, 2022

(54) METHOD AND APPARATUS FOR ANALYZING VIDEO SCENARIO

(71) Applicant: BEIJING BAIDU NETCOM SCIENCE AND TECHNOLOGY CO., LTD., Beijing (CN)

(72) Inventors: Xuetong XUE, Beijing (CN); Hui REN, Beijing (CN); Min YANG, Beijing (CN)

(21) Appl. No.: 17/191,438

(22) Filed: Mar. 3, 2021

(30) Foreign Application Priority Data
Jul. 14, 2020 (CN) 202010673408.0

(51) Int. Cl. G06K 9/00; G06K 9/62

(52) U.S. Cl. CPC G06K 9/00718; G06K 9/00744; G06K 9/6215; G06K 9/6261; G06K 9/6256

(57) ABSTRACT

The present disclosure provides a method and an apparatus for analyzing a video scenario, and relates to the field of image recognition technology. A specific embodiment includes: extracting a frame of picture from a to-be-analyzed video at a preset time interval, recording a position of each frame of picture in the video, and establishing an index table of the picture and the position; labeling the each extracted frame of picture through a pre-trained scenario classification model, and adding a label of the extracted frame of picture to the index table; aggregating labels in the index table, and marking a new label to the picture in the index table; and outputting a position corresponding to the new label in the index table.

### CROSS-REFERENCE TO RELATED APPLICATION

This application claims the priority of Chinese Patent Application No. 202010673408.0, titled “METHOD AND APPARATUS FOR ANALYZING VIDEO SCENARIO”, filed on Jul. 14, 2020, the content of which is incorporated herein by reference in its entirety.

### TECHNICAL FIELD

The present disclosure relates to the field of computer science, specifically to the field of image recognition technology.

### BACKGROUND

A complete video usually contains multiple semantic-level segments, i.e., different scenarios. By dividing the scenarios, the difficulty of analyzing the complete video may be reduced and the semantic level labels (scenario labels) of the video may be provided at the same time. On this basis, the segments of the video may be retrieved, the relevant advertisements (more in line with the scenarios) may be inserted, and the video may be segmented for the subsequent understanding, analysis, recognition and classification, etc.

In the existing technology, a content analysis is executed on the segments of the complete video, and the conversion positions of the scenario shots are detected, and the video is disassembled into multiple shot segments. In one scenario, an edited video captured by a user includes multiple scenarios (such as a bedroom, a toilet, a living room and a kitchen), and an algorithm analyzes the video, automatically disassembles the video into four scenario segments, and labels the video segment. In another scenario, a segment of a television drama includes multiple scenarios (such as waiting for a car, eating, chatting and reading), and the algorithm identifies and analyzes the behaviors of the different scenarios and labels the different scenarios or behaviors, based on the analysis of the video content.

### SUMMARY

The present disclosure provides a method, apparatus, device and storage medium for analyzing a video scenario.

In a first aspect, the present disclosure provides a method for analyzing a video scenario, including: extracting a frame of picture from a to-be-analyzed video at a preset time interval, recording a position of each extracted frame of picture in the video, and establishing an index table of the picture and the position; labeling each extracted frame of picture through a pre-trained scenario classification model, and adding the label of each extracted frame of picture to the index table; aggregating labels in the index table, and marking a new label to the picture in the index table; and outputting a position corresponding to the new label in the index table.

In a second aspect, the present disclosure provides an apparatus for analyzing a video scenario, including: an extraction unit, configured to extract a frame of picture from a to-be-analyzed video at a preset time interval, record a position of each extracted frame of picture in the video, and establish an index table of the picture and the position; a labeling unit, configured to label each extracted frame of picture through a pre-trained scenario classification model, and add the label of each extracted frame of picture to the index table; an aggregation unit, configured to aggregate labels in the index table, and marking a new label to the picture in the index table; and an output unit, configured to output a position corresponding to the new label in the index table.

In a third aspect, the present disclosure provides an electronic device, including: at least one processor; and a memory communicating with the at least one processor; where the memory stores instructions executable by the at least one processor, and the instructions, when executed by the at least one processor, cause the at least one processor to execute the method as described in any one of the implementations of the first aspect.

In a fourth aspect, the present disclosure provides a non-transitory computer readable storage medium storing computer instructions, where the computer instructions cause a computer to execute the method as described in any one of the implementations of the first aspect.

It should be appreciated that the content described in this part is not intended to identify the key or critical features of the embodiments of the present disclosure, nor is it intended to limit the scope of the present disclosure. The other features of the present disclosure will become easy to understand through the following description.

### BRIEF DESCRIPTION OF THE DRAWINGS

The accompanying drawings are intended to provide a better understanding of the present disclosure and do not constitute a limitation to the present disclosure:

FIG. 1 is an example system architecture diagram in which an embodiment of the present disclosure may be applied;

FIG. 2 is a flowchart of an embodiment of a method for analyzing a video scenario according to the present disclosure;

FIG. 3 is a schematic diagram of an application scenario of the method for analyzing the video scenario according to the present disclosure;

FIG. 4 is a flowchart of another embodiment of the method for analyzing the video scenario according to the present disclosure;

FIG. 5 is a schematic structural diagram of an embodiment of an apparatus for analyzing the video scenario according to the present disclosure; and

FIG. 6 is a block diagram of an electronic device adapted to implement the method for analyzing the video scenario of an embodiment of the present disclosure.

### DETAILED DESCRIPTION OF EMBODIMENTS

The example embodiments of the present disclosure will be described below with reference to the accompanying drawings, in which various details of the embodiments of the present disclosure are included to facilitate understanding, and should be considered as examples only. Accordingly, those of ordinary skill in the art should recognize that various changes and modifications may be made to the embodiments described herein without departing from the scope and spirit of the present disclosure. Likewise, for clarity and conciseness, descriptions of well-known functions and structures are omitted in the following description.

The techniques of the present disclosure utilize stronger, higher-level semantic features to avoid manual design features. Model training is executed on a large-scale scenario classification data set, which may better recognize and extract the scenario information. By avoiding analyzing the video as a whole, detecting the acquired frame of picture of the video may reduce the calculation amount and improve the processing speed. The attribution relationship is determined to obtain different scenario shots through the bidirectional continuous segment aggregation analysis.

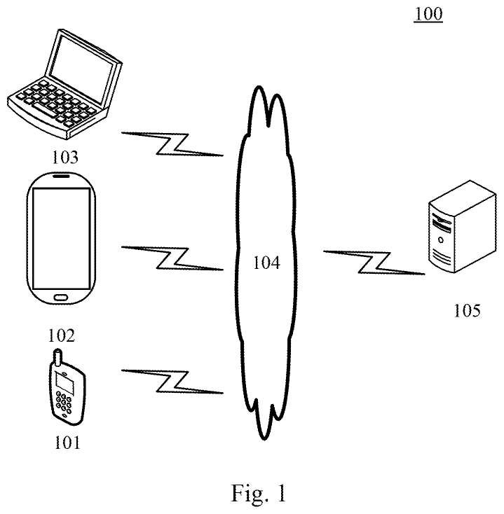

FIG. 1 shows an example system architecture 100 of an embodiment in which a method or an apparatus for analyzing a video scenario according to the present disclosure may be applied.

As shown in FIG. 1, the system architecture 100 may include terminal devices 101, 102 and 103, a network 104, and a server 105. The network 104 serves as a medium providing a communication link between the terminal devices 101, 102 and 103 and the server 105. The networks 104 may include various types of connections, such as wired or wireless communication links, or optical fiber cables.

A user may use the terminal devices 101, 102 and 103 to interact with the server 105 through the network 104 to receive or send messages. Various communication client applications, such as a video playback application, a web browser application, a shopping application, a search application, an instant messaging tool, a mailbox client and social platform software may be installed on the terminal devices 101, 102 and 103.

The terminal devices 101, 102, 103 may be hardware or software. When the terminal devices 101, 102, 103 are hardware, they may be various electronic devices having a display screen and supporting video playback, including but not limited to, a smart phone, a tablet computer, an electronic book reader, a MP3 (Moving Picture Experts Group Audio Layer III) player, a MP4 (Moving Picture Experts Group Audio Layer IV) player, a laptop portable computer and a desktop computer. When the terminal devices 101, 102, 103 are software, the software may be installed in the electronic device. The software may be implemented as multiple software pieces or software modules (such as for providing distributed services), or as a single software piece or software module, which is not specifically limited herein.

The server 105 may be a server providing various services, such as a background video server providing support for video played on the terminal devices 101, 102, 103. The background video server may execute a process, such as an analysis on the received video, and feed back the processing result (such as video scenario labels) to the terminal devices.

It should be noted that the server may be hardware of software. When the server is hardware, it may be implemented as a distributed server cluster composed of a plurality of servers, or as a single server. When the server is software, it may be implemented as multiple software pieces or software modules (e.g., multiple software pieces or software modules for providing distributed services), or as a single software piece or software module, which are not specifically limited herein.

It should be noted that the method for analyzing the video scenario provided by the embodiments of the present disclosure is generally executed by the server 105. Correspondingly, the apparatus for analyzing the video scenario is generally provided in the server 105.

It should be appreciated that the number of the terminal devices, the network, and the server in FIG. 1 is merely illustrative. Any number of terminal devices, networks, and servers may be provided based on actual requirements.

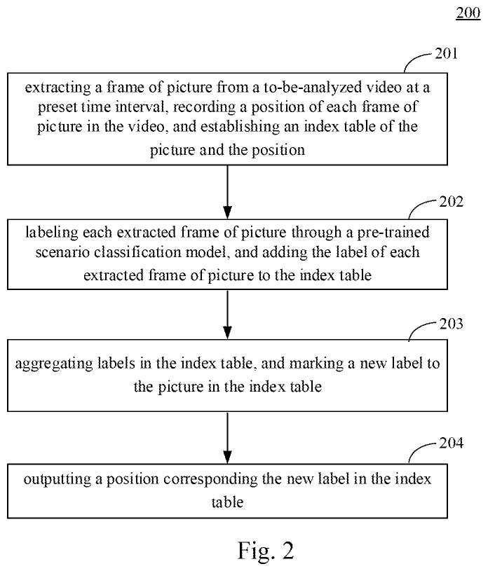

Further referring to FIG. 2, a flow 200 of an embodiment of a method for analyzing a video scenario according to the present disclosure is shown. The method includes the following steps 201 to 204.

Step 201 includes extracting a frame of picture from a to-be-analyzed video at a preset time interval, recording a position of each frame of picture in the video, and establishing an index table of the picture and the position.

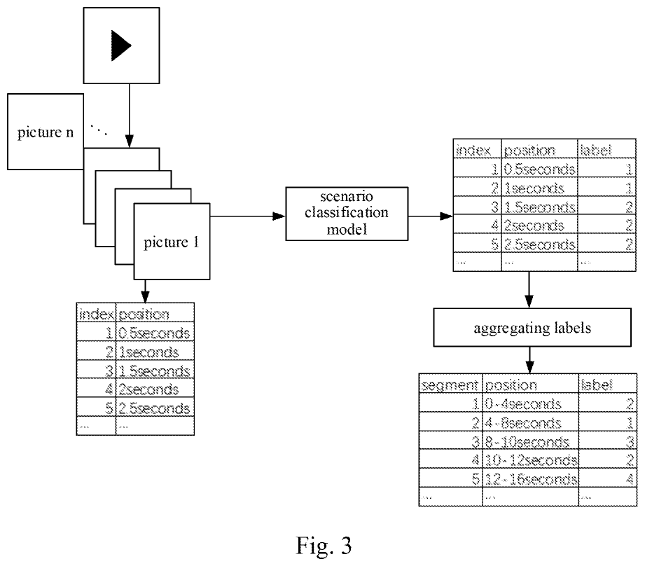

In this embodiment, the execution body of the method for analyzing a video scenario (such as the server shown in FIG. 1) may divide the complete to-be-analyzed video into basic detection units at preset time interval, and then extract a frame of picture from the same position in each basic detection unit, i.e., execute sampling, such as extracting a picture at the end of each basic detection unit. The video frames in each basic detection unit are considered to be the same scenario. For example, 0.5 seconds may be set as a basic detection unit and a frame of picture may be extracted every 0.5 seconds. The sampling time interval may be determined based on the total length of the video. The extracted position of each frame of picture in the original video is recorded, for example, at 0.5 seconds. The index table of the pictures and the positions is established by numbering each picture numbered in a chronological order, as shown in FIG. 3.

Step 202 includes labeling each extracted frame of picture through a pre-trained scenario classification model, and adding the label of each extracted frame of picture to the index table.

In this embodiment, the scenario classification model is a neural network for classification. The scenario classification model (such as VGG, and ResNet), which may be pre-trained on the Place365 large-scale scenario classification data set including 365 scenarios and a total of 8 million pictures, may be used to well cover various scenarios. Each picture is input to the scenario classification model, and the label of each picture may be obtained. The label of each picture is recorded in the index table. The labels may be represented by characters, and may be simplified to numbers, such as 1 for living rooms, 2 for restaurants and 3 for classrooms.

Step 203 includes aggregating labels in the index table, and marking a new label to the picture in the index table.

In this embodiment, the labels of adjacent pictures in the index table may be aggregated. There are three aggregation ways: forward aggregation, reverse aggregation, and bidirectional aggregation. The forward aggregation is forward aggregating the labels in the index table in an order of positions from front to back. The reverse aggregation is the reverse aggregating labels in the index table in an order of positions from back to front. The bidirectional aggregation combines the result of the forward aggregation with the result of the reverse aggregation. A suitable aggregation may be selected based on factors, such as the video length and the usage. For example, the forward or reverse aggregation may be selected if the video is long, and the bidirectional aggregation may be selected if the video is short. The aggregation effects of different types may be analyzed to determine which of the types of the aggregation is most suitable for the video. Multiple aggregation ways may improve the flexibility of a scenario analysis, and execute a targeted scenario analysis. The labels in the index table may be grouped in sequence (actually also grouping pictures), with each label group including a preset number of labels. For example, eight adjacent labels are grouped in a front-to-back order or a back-to-front order. If there are 8000 pictures, there are 8000 labels, which may be divided into 1000 groups. For each label group, if there is a label in the label group that exceed the proportion threshold, the labels in the label group are changed to the label that exceed the proportion threshold in the label group. For example, the proportion threshold is set at 0.7, and there are six labels A, one label B, and one label C in the label group. Then, since the number of labels A is greater than 8*0.7, the labels in the label group are merged as the label A.

Step 204 includes outputting a position corresponding to each label in the index table.

In this embodiment, the span of the label obtained by merging is multiple basic detection units, and successive segments use one label, i.e., one scenario. For example, the scenario of the video from 1 to 5 seconds is classroom and the scenario of the video from 4 to 12 seconds is playground. The switch position of the labels is the switch position of the shots. Alternatively, the corresponding recommendation information may be selected according to the label, such as recommending soy sauce in a kitchen scenario.

The method provided in the above embodiment of the present disclosure may effectively solve the problem that the feature obtained based on the color or the gray value may not express the scenario semantic information. Using a large-scale scenario classification data set classification model may extract more scenario information, and is beneficial to understanding and recognizing the scenario. The bidirectional aggregation analysis of the scenario labels is provided to determine the scenario attribution relationship, thereby obtaining a more accurate scenario segmentation result.

Further referring to FIG. 3, FIG. 3 is a schematic diagram of an application scenario of the method for analyzing the video scenario according to the present disclosure. In the application scenario of FIG. 3, the server samples the to-be-analyzed video and extracts a frame of picture every 0.5 seconds. The extracting location and an index are recorded. Each frame of picture is labeled through the pre-trained scenario classification model, and the label is also added to the index table. The adjacent labels are then merged in the index table in an order of positions from front to back. The labels in the first row are labels before merging, and the labels in the second row are labels after merging. If the original sliding window (a preset number of adjacent areas) is 8, and the proportion of the label 1 in the first to eighth labels is greater than the proportion threshold (assuming 0.6), the first to eighth labels are then merged as label 1. If there are no labels whose proportion is greater than the proportion threshold in the ninth to sixteenth labels, the sliding window is reduced to 4. If the proportion of the label 3 is greater than the proportion threshold in the ninth to twelfth labels, the ninth to twelfth labels are then merged as label 3. Continuing to slide back to take out eight labels, and if the proportion of the label 2 in the thirteenth to twentieth labels is greater than the proportion threshold, the thirteenth to twentieth labels are then merged as label 2. As shown in Table 1:

TABLE 1

| | | | | | | | | | | | | | | | | | | | |
|---|---|---|---|---|---|---|---|---|---|---|---|---|---|---|---|---|---|---|---|
| 1 | 2 | 1 | 1 | 0 | 1 | 1 | 2 | 2 | 3 | 3 | 3 | 4 | 2 | 1 | 1 | 2 | 2 | 2 | 2 |

| | | |
|---|---|---|
| 1 | 3 | 2 |

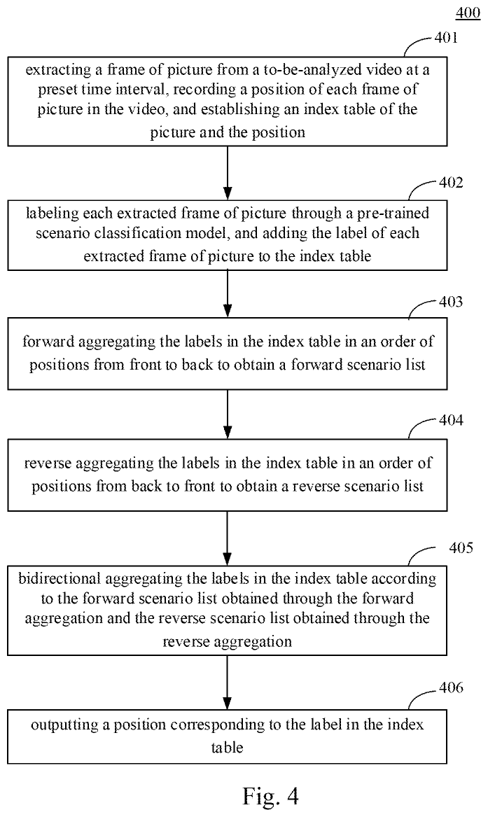

Further referring to FIG. 4, a flow 400 of another embodiment of the method for analyzing the video scenario according to the present disclosure is shown. The flow 400 includes the following steps 401 to 406.

Step 401 includes extracting a frame of picture from a to-be-analyzed video at a preset time interval, recording a position of each frame of picture in the video, and establishing an index table of the picture and the position.

Step 402 includes labeling each extracted frame of picture through a pre-trained scenario classification model, and adding the label of each extracted frame of picture to the index table.

Since the steps 401 to 402 are substantially the same as the steps 201 to 202, and details are not described herein.

Step 403 includes forward aggregating the labels in the index table in an order of positions from front to back to obtain a forward scenario list.

In this embodiment, the steps of the forward aggregation are executed by taking a first label in the index table as a start point: acquiring a preset number of adjacent labels from the start point as a first label group, and detecting whether there is a label in the first label group that has a proportion exceeding a proportion threshold; changing, if there is the label that has the proportion exceeding the proportion threshold in the first label group, all labels in the first label group to the label that has the proportion exceeding the proportion threshold.

The execution of the steps of the forward aggregation is continued by taking a label adjacent to the first label group as a start point until all labels in the index table are detected, to obtain the forward scenario list. Therefore, the adjacent labels are merged, and the labels with a small proportion are filtered out, thereby reducing the frequency of scenario switch. As shown in Table 2:

TABLE 2

| | | | | | | | | | | | | | | | | | | | | | | | |
|---|---|---|---|---|---|---|---|---|---|---|---|---|---|---|---|---|---|---|---|---|---|---|---|
| 1 | 2 | 1 | 1 | 0 | 1 | 1 | 2 | 2 | 3 | 3 | 3 | 4 | 2 | 3 | 3 | 2 | 2 | 2 | 2 | 3 | 3 | 3 | 2 |

| | | | |
|---|---|---|---|
| 1 | 3 | 2 | 3 |

Alternatively, the labels may be grouped dynamically, initially in a larger group, and if in the group no labels whose proportions exceed the proportion threshold are found, the group may be shrank (such as shrank to a half of the initial group), and an attempt is made to find a label whose proportion exceeds the proportion threshold. If the merging is still not possible after the second grouping, the merging of subsequent labels is then started. For example, whether the proportion of the same labels in eight adjacent labels exceeds the threshold a, and if the proportion exceeds the threshold a, these eight neighborhoods are merged as a given label; if the proportion does not exceed the threshold a, the eight adjacent labels are reduced to four neighbors and the same check is made. If the threshold a is exceeded, segments are then merged, and the end of the segments is set as the new start point. Otherwise, the segments are not merged, and the detection start point is shifted back, thereby making the scenario switch smoother.

Step 404 includes reverse aggregating the labels in the index table in an order of positions from back to front to obtain a reverse scenario list.

In this embodiment, the steps of the reverse aggregation are executed by taking a last label in the index table as a start point: acquiring a preset number of adjacent labels from the start point as a first label group, and detecting whether there is a label in the first label group that has a proportion exceeding a proportion threshold; changing, if there is the label that has the proportion exceeding the proportion threshold in the first label group, all labels in the first label group to the label that has the proportion exceeding the proportion threshold.

The execution of the steps of the reverse aggregation is continued by taking a label adjacent to the first label group as a start point until a first label in the index table is detected to obtain the reverse scenario list. Therefore, the adjacent labels are merged, and the labels with a small proportion are filtered out, thereby reducing the frequency of scenario conversion. As shown in Table 3:

TABLE 3

| | | | | | | | | | | | | | | | | | | | | | | | |
|---|---|---|---|---|---|---|---|---|---|---|---|---|---|---|---|---|---|---|---|---|---|---|---|
| 1 | 2 | 1 | 1 | 0 | 1 | 1 | 2 | 2 | 3 | 3 | 3 | 4 | 2 | 3 | 3 | 2 | 2 | 2 | 2 | 3 | 3 | 3 | 2 |

| | | |
|---|---|---|
| 1 | 3 | 2 |

The reverse aggregation may also take the way of the dynamic grouping described in the step 403.

Step 405 includes performing bidirectional aggregating using the forward scenario list and the reverse scenario list, to update labels of the pictures in the index.

In this embodiment, the video is divided into at least one scenario segment based on the positions; and for each scenario segment of the at least one scenario segment, if a similarity between a forward scenario list and a reverse scenario list corresponding to each scenario segment is not smaller than a preset similarity threshold, the label in the forward scenario list is used as the label of the scenario segment. Assuming that the 24-frames of picture is a scenario segment, the similarity between the second row in Table 2 and the second row in Table 3 may be compared, and if the similarity is greater than the preset similarity threshold, the results of Table 2 are used. The two aggregation ways are checked against each other to avoid misdetection due to abnormal conditions in some ways.

In some alternative implementations of this embodiment, for each scenario segment of the at least one scenario segment, if the similarity between the forward scenario list and the reverse scenario list corresponding to each scenario segment is smaller than the preset similarity threshold, the proportion threshold used in the forward aggregation is reduced to execute a second forward aggregation, and a label obtained through the second forward aggregation is used as the label of the scenario segment. For example, the proportion threshold used in the first forward aggregation is 0.7, and the similarity between the forward scenario list and the reverse scenario list is smaller than the preset similarity threshold, and then, the proportion threshold may be reduced to 0.6 and the forward aggregation may be re-executed and the result of the forward aggregation is used as the final result. The second forward aggregation may make the scenario analysis result more accurate and reducing the proportion threshold may make the scenario switch smoother.

Step 406 includes outputting a position corresponding to each label in the index table.

Since the step 406 is substantially the same as the step 204, and details are not described herein.

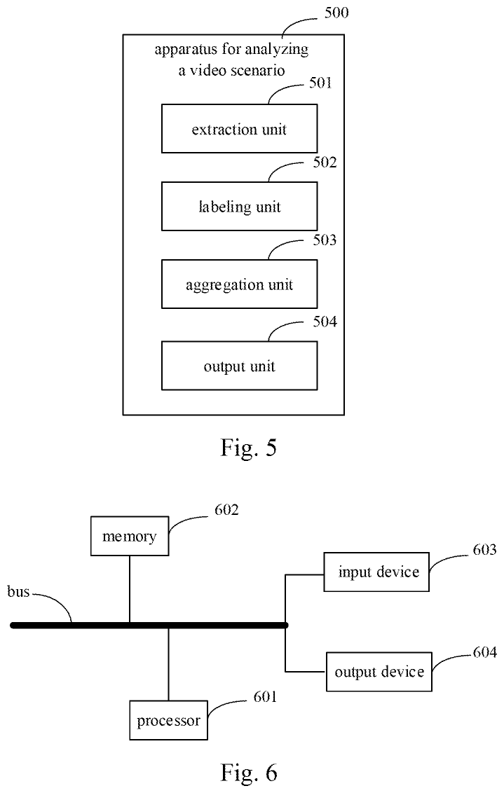

Further referring FIG. 5, as an implementation of the method shown in above figures, the present disclosure provides an embodiment of an apparatus for analyzing the video scenario, which corresponds to the embodiment of the method shown in FIG. 2, and the apparatus may be applied in various electronic devices.

As shown in FIG. 5, the apparatus 500 for analyzing the video scenario in this embodiment includes: an extraction unit 501, a labeling unit 502, an aggregation unit 503 and an output unit 504. The extraction unit 501 is configured to extract a frame of picture from a to-be-analyzed video at a preset time interval, record a position of each frame of picture in the video, and establish an index table of the picture and the position; the labeling unit 502 is configured to label each extracted frame of picture through a pre-trained scenario classification model, and add the label of each extracted frame of picture to the index table; the aggregation unit 503 is configured to aggregate labels in the index table, and mark a new label to the picture in the index table; and the output unit 504 is configured to output a position corresponding to the label in the index table.

In this embodiment, for specific processes of the extraction unit 501, the labeling unit 502, the aggregation unit 503 and the output unit 504 of the apparatus for analyzing the video scenario, reference may be made to relative descriptions of the step 201, the step 202, the step 203 and the step 204 in corresponding embodiments of FIG. 2 respectively, and details are not described herein.

In some alternative implementations of this embodiment, the aggregation unit 503 is further configured to: forward aggregate the labels in the index table in an order of positions from front to back to obtain a forward scenario list; reverse aggregate the labels in the index table in an order of positions from back to front to obtain a reverse scenario list; and bidirectional aggregate the labels in the index table according to the forward scenario list obtained through the forward aggregation and the reverse scenario list obtained through the reverse aggregation.

In some alternative implementations of this embodiment, the aggregation unit 503 is further configured to: execute the steps of the forward aggregation by taking a first label in the index table as a start point: acquiring a preset number of adjacent labels from the start point as a first label group, and detecting whether there is a label in the first label group that has a proportion exceeding a proportion threshold; changing, if there is the label that has the proportion exceeding the proportion threshold in the first label group, the labels in the first label group to the label that has the proportion exceeding the proportion threshold; and continuing executing the steps of the forward aggregation by taking a label adjacent to the first label group as a start point until all labels in the index table are detected to obtain the forward scenario list.

In some alternative implementations of this embodiment, the aggregation unit 503 is further configured to: execute the steps of the reverse aggregation by taking a last label in the index table as a start point: acquiring a preset number of adjacent labels from the start point as a first label group, and detecting whether there is a label in the first label group that has a proportion exceeding a proportion threshold; changing, if there is the label that has the proportion exceeding the proportion threshold in the first label group, the labels in the first label group to the label that has the proportion exceeding the proportion threshold; and continuing executing the steps of the reverse aggregation by taking a label adjacent to the first label group as a start point until a first label in the index table is detected, to obtain the reverse scenario list.

In some alternative implementations of this embodiment, the aggregation unit 503 is further configured to: reduce the preset number of adjacent labels to continue executing the steps of the forward aggregation or the reverse aggregation, if there is no label that has a proportion exceeding a proportion threshold in the first label group.

In some alternative implementations of this embodiment, the aggregation unit 503 is further configured to: divide the video into at least one scenario segment according to the position; for each scenario segment of the at least one scenario segment, use, if a similarity between the forward scenario list and the reverse scenario list corresponding to each scenario segment is not smaller than a preset similarity threshold, the label in the forward scenario list as the label of the scenario segment.

In some alternative implementations of this embodiment, the aggregation unit 503 is further configured to: for each scenario segment of the at least one scenario segment, reduce, if the similarity between the forward scenario list and the reverse scenario list corresponding to each scenario segment is smaller than the preset similarity threshold, the proportion threshold used in the forward aggregation to execute a second forward aggregation, and use a label obtained through the second forward aggregation as the label of the scenario segment.

According to an embodiment of the present disclosure, the present disclosure further provides an electronic device and a readable storage medium.

As shown in FIG. 6, FIG. 6 is a block diagram of an electronic device adapted to implement the method for analyzing the video scenario of an embodiment of the present disclosure. The electronic device is intended to represent various forms of digital computers, such as laptops, desktops, worktables, personal digital assistants, servers, blade servers, mainframe computers and other suitable computers. The electronic device may also represent various forms of mobile devices, such as personal digital processing, cellular phones, smart phones, wearable devices and other similar computing devices. The parts, their connections and relationships, and their functions shown herein are examples only, and are not intended to limit the implementations of the present disclosure as described and/or claimed herein.

As shown in FIG. 6, the electronic device includes one or more processors 601, a memory 602, and interfaces for connecting components, including a high-speed interface and a low-speed interface. The components are interconnected by using different buses and may be mounted on a common motherboard or otherwise as desired. The processor may process instructions executed within the electronic device, including instructions stored in memory or on memory to display graphical information of the GUI on an external input or output device (such as a display device coupled to an interface). In other embodiments, multiple processors and/or multiple buses may be used with multiple memories, if desired. Similarly, multiple electronic devices may be connected, each of which provides some of the necessary operations (such as a server array, a set of blade servers, or a multiprocessor system). An example of a processor 601 is shown in FIG. 6.

The memory 602 is a non-transitory computer readable storage medium provided by the present disclosure. The memory stores instructions executable by at least one processor to cause the at least one processor to execute the method for analyzing the video scenario provided by the present disclosure. The non-transitory computer readable storage medium of the present disclosure stores computer instructions for causing a computer to execute the method for analyzing the video scenario provided by the present disclosure.

As a non-transitory computer readable storage medium, the memory 602 may be used to store non-transitory software programs, non-transitory computer executable programs and modules, such as the program instructions or modules corresponding to the method for analyzing the video scenario in the embodiment of the present disclosure (such as the extraction unit 501, the labeling unit 502, the aggregation unit 503 and the output unit 504 shown in FIG. 5). The processor 601 runs the non-transitory software programs, instructions and modules stored in the memory 602 to execute various functional applications and data processing of the server, thereby implementing the method for analyzing the video scenario in the above embodiment of the method.

The memory 602 may include a storage program area and a storage data area, where the storage program area may store an operating system and an application program required by at least one function; and the storage data area may store data created by the use of the electronic device according to the method for analyzing the video scenario and the like. In addition, the memory 602 may include a high-speed random access memory, and may also include a non-transitory memory, such as at least one magnetic disk storage device, a flash memory or other non-transitory solid state storage devices. In some embodiments, the memory 602 may optionally include a memory disposed remotely relative to the processor 601, which may be connected through a network to the electronic device of the method for analyzing the video scenario. Examples of such networks include, but are not limited to, the Internet, enterprise intranets, local area networks, mobile communication networks and combinations thereof.

The electronic device of the method for analyzing the video scenario may further include an input device 603 and an output device 604. The processor 601, the memory 602, the input device 603 and the output device 604 may be interconnected through a bus or other means, and an example of a connection through a bus is shown in FIG. 6.

The input device 603 may receive input number or character information, and generate key signal input related to user settings and functional control of the electronic device of the method for analyzing the video scenario, such as a touch screen, a keypad, a mouse, a track pad, a touch pad, a pointer bar, one or more mouse buttons, a trackball or a joystick. The output device 604 may include a display device, an auxiliary lighting device (such as an LED), and a tactile feedback device (such as a vibration motor) and the like. The display device may include, but is not limited to, a liquid crystal display (LCD), a light emitting diode (LED) display and a plasma display. In some embodiments, the display device may be a touch screen.

The various embodiments of the systems and technologies described herein may be implemented in digital electronic circuit systems, integrated circuit systems, ASICs (application specific integrated circuits), computer hardware, firmware, software and/or combinations thereof. These various embodiments may include: being implemented in one or more computer programs, where the one or more computer programs may be executed and/or interpreted on a programmable system including at least one programmable processor, and the programmable processor may be a dedicated or general purpose programmable processor, which may receive data and instructions from a memory system, at least one input device and at least one output device, and send the data and instructions to the memory system, the at least one input device and the at least one output device.

These computing programs (also known as programs, software, software applications or code) include machine instructions of a programmable processor and may be implemented in high-level procedures and/or object-oriented programming languages, and/or assembly or machine languages. As used herein, the terms “machine readable medium” and “computer readable medium” refer to any computer program product, device and/or apparatus (such as magnetic disk, optical disk, memory or programmable logic device (PLD)) for providing machine instructions and/or data to a programmable processor, including a machine readable medium that receives machine instructions as machine readable signals. The term “machine readable signal” refers to any signal used to provide machine instructions and/or data to a programmable processor.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementation of the systems and technologies described herein) or a computing system including any combination of such background component, middleware component or front-end component. The components of the system may be interconnected by any form or medium of digital data communication (such as a communication network). Examples of communication networks include a local area network (LAN), a wide area network (WAN) and the Internet.

The computer system may include a client and a server. The client and the server are typically remote from each other and typically interact through a communication network. The relationship between the client and the server is generated by a computer program running on the corresponding computer and having a client-server relationship with each other.

The technical solutions of the present disclosure may effectively solve the problem that the feature obtained based on the color or the gray value may not express the scenario semantic information. Using a large-scale scenario classification data set classification model may extract more scenario information, and is beneficial to understanding and recognizing the scenario. The bidirectional aggregation analysis of the scenario labels is provided to determine the scenario attribution relationship, thereby obtaining a more accurate scenario segmentation result.

It should be appreciated that the steps of reordering, adding or deleting may be executed using the various forms shown above. For example, the steps described in the present disclosure may be executed in parallel or sequentially or in a different order, so long as the desired results of the technical solutions disclosed in the present disclosure may be realized, and no limitation is imposed herein.

The above specific description is not intended to limit the scope of the present disclosure. It should be appreciated by those skilled in the art that various modifications, combinations, sub-combinations and substitutions may be made depending on design requirements and other factors. Any modification, equivalent and modification that fall within the spirit and principles of the present disclosure are intended to be included within the scope of the present disclosure.

What is claimed is:

1. A method for analyzing a video scenario, the method comprising:
extracting a frame of picture from a to-be-analyzed video at a preset time interval, recording a position of each extracted frame of picture in the video, and establishing an index table of the picture and the position;
labeling the each extracted frame of picture through a pre-trained scenario classification model, and adding a label of the each extracted frame of picture to the index table;
aggregating labels in the index table, and marking a new label to the picture in the index table; and
outputting a position corresponding to the new label in the index table.

2. The method according to claim 1, wherein the aggregating labels in the index table, and marking a new label to the picture in the index table, comprises any one of following ways:
forward aggregating the labels in the index table in an order of positions from front to back to obtain a forward scenario list;
reverse aggregating the labels in the index table in an order of positions from back to front to obtain a reverse scenario list; and
bidirectional aggregating the labels in the index table according to the forward scenario list obtained through the forward aggregation and the reverse scenario list obtained through the reverse aggregation.

3. The method according to claim 2, wherein the forward aggregating the labels in the index table in an order of positions from front to back to obtain a forward scenario list, comprises:
executing steps of the forward aggregation by taking a first label in the index table as a start point: acquiring a preset number of adjacent labels from the start point as a first label group, and detecting whether there is a label that has a proportion exceeding a proportion threshold in the first label group; changing, if there is the label that has the proportion exceeding the proportion threshold in the first label group, the labels in the first label group to the label that has the proportion exceeding the proportion threshold; and
continuing executing the steps of the forward aggregation by taking a label adjacent to the first label group as a start point until all labels in the index table are detected, to obtain the forward scenario list.

4. The method according to claim 2, wherein the reverse aggregating the labels in the index table in an order of positions from back to front to obtain a reverse scenario list, comprises:
executing steps of the reverse aggregation by taking a last label in the index table as a start point: acquiring a preset number of adjacent labels from the start point as a first label group, and detecting whether there is a label that has a proportion exceeding a proportion threshold in the first label group; changing, if there is the label that has the proportion exceeding the proportion threshold in the first label group, the labels in the first label group to the label that has the proportion exceeding the proportion threshold; and
continuing executing the steps of the reverse aggregation by taking a label adjacent to the first label group as a start point until a first label in the index table is detected to obtain the reverse scenario list.

5. The method according to claim 3, wherein the method further comprises:
reducing the preset number of adjacent labels to continue executing the steps of the forward aggregation or the reverse aggregation, if there is no label that has the proportion exceeding the proportion threshold in the first label group.

6. The method according to claim 2, wherein the bidirectional aggregating the labels in the index table according to the forward scenario list obtained through the forward aggregation and the reverse scenario list obtained through the reverse aggregation, comprises:
dividing the video into at least one scenario segment; and
for each scenario segment of the at least one scenario segment, using, if a similarity between the forward scenario list and the reverse scenario list corresponding to the each scenario segment is not smaller than a preset similarity threshold, the label in the forward scenario list as a label of the each scenario segment.

7. The method according to claim 6, wherein the method further comprises:
for the each scenario segment of the at least one scenario segment, reducing, if the similarity between the forward scenario list and the reverse scenario list corresponding to the each scenario segment is smaller than the preset similarity threshold, the proportion threshold used in the forward aggregation to execute a second forward aggregation, and using a label obtained through the second forward aggregation as the label of the each scenario segment.

8. An electronic device, comprising:
at least one processor; and
a memory communicating with the at least one processor; wherein the memory stores instructions executable by the at least one processor, and the instructions, when executed by the at least one processor, cause the at least one processor to execute operations comprising:
extracting a frame of picture from a to-be-analyzed video at a preset time interval, recording a position of each extracted frame of picture in the video, and establishing an index table of the picture and the position;
labeling the each extracted frame of picture through a pre-trained scenario classification model, and adding a label of the each extracted frame of picture to the index table;
aggregating labels in the index table, and marking a new label to the picture in the index table; and
outputting a position corresponding to the new label in the index table.

9. The electronic device according to claim 8, wherein the aggregating labels in the index table, and marking a new label to the picture in the index table, comprises any one of following ways:
forward aggregating the labels in the index table in an order of positions from front to back to obtain a forward scenario list;
reverse aggregating the labels in the index table in an order of positions from back to front to obtain a reverse scenario list; and
bidirectional aggregating the labels in the index table according to the forward scenario list obtained through the forward aggregation and the reverse scenario list obtained through the reverse aggregation.

10. The electronic device according to claim 9, wherein the forward aggregating the labels in the index table in an order of positions from front to back to obtain a forward scenario list, comprises:
executing steps of the forward aggregation by taking a first label in the index table as a start point: acquiring a preset number of adjacent labels from the start point as a first label group, and detecting whether there is a label that has a proportion exceeding a proportion threshold in the first label group; changing, if there is the label that has the proportion exceeding the proportion threshold in the first label group, the labels in the first label group to the label that has the proportion exceeding the proportion threshold; and
continuing executing the steps of the forward aggregation by taking a label adjacent to the first label group as a start point until all labels in the index table are detected, to obtain the forward scenario list.

11. The electronic device according to claim 9, wherein the reverse aggregating the labels in the index table in an order of positions from back to front to obtain a reverse scenario list, comprises:
executing steps of the reverse aggregation by taking a last label in the index table as a start point: acquiring a preset number of adjacent labels from the start point as a first label group, and detecting whether there is a label that has a proportion exceeding a proportion threshold in the first label group; changing, if there is the label that has the proportion exceeding the proportion threshold in the first label group, the labels in the first label group to the label that has the proportion exceeding the proportion threshold; and
continuing executing the steps of the reverse aggregation by taking a label adjacent to the first label group as a start point until a first label in the index table is detected to obtain the reverse scenario list.

12. The electronic device according to claim 10, wherein the operations further comprise:
reducing the preset number of adjacent labels to continue executing the steps of the forward aggregation or the reverse aggregation, if there is no label that has the proportion exceeding the proportion threshold in the first label group.

13. The electronic device according to claim 9, wherein the bidirectional aggregating the labels in the index table according to the forward scenario list obtained through the forward aggregation and the reverse scenario list obtained through the reverse aggregation, comprises:
dividing the video into at least one scenario segment; and
for each scenario segment of the at least one scenario segment, using, if a similarity between the forward scenario list and the reverse scenario list corresponding to the each scenario segment is not smaller than a preset similarity threshold, the label in the forward scenario list as a label of the each scenario segment.

14. The electronic device according to claim 13, wherein the operations further comprise:
for the each scenario segment of the at least one scenario segment, reducing, if the similarity between the forward scenario list and the reverse scenario list corresponding to the each scenario segment is smaller than the preset similarity threshold, the proportion threshold used in the forward aggregation to execute a second forward aggregation, and using a label obtained through the second forward aggregation as the label of the each scenario segment.

15. A non-transitory computer readable storage medium storing computer instructions, wherein the computer instructions cause a computer to execute operations comprising:
extracting a frame of picture from a to-be-analyzed video at a preset time interval, recording a position of each extracted frame of picture in the video, and establishing an index table of the picture and the position;
labeling the each extracted frame of picture through a pre-trained scenario classification model, and adding a label of the each extracted frame of picture to the index table;
aggregating labels in the index table, and marking a new label to the picture in the index table; and
outputting a position corresponding to the new label in the index table.

16. The non-transitory computer readable storage medium according to claim 15, wherein the aggregating labels in the index table, and marking a new label to the picture in the index table, comprises any one of following ways:
forward aggregating the labels in the index table in an order of positions from front to back to obtain a forward scenario list;
reverse aggregating the labels in the index table in an order of positions from back to front to obtain a reverse scenario list; and
bidirectional aggregating the labels in the index table according to the forward scenario list obtained through the forward aggregation and the reverse scenario list obtained through the reverse aggregation.

17. The non-transitory computer readable storage medium according to claim 16, wherein the forward aggregating the labels in the index table in an order of positions from front to back to obtain a forward scenario list, comprises:
executing steps of the forward aggregation by taking a first label in the index table as a start point: acquiring a preset number of adjacent labels from the start point as a first label group, and detecting whether there is a label that has a proportion exceeding a proportion threshold in the first label group; changing, if there is the label that has the proportion exceeding the proportion threshold in the first label group, the labels in the first label group to the label that has the proportion exceeding the proportion threshold; and
continuing executing the steps of the forward aggregation by taking a label adjacent to the first label group as a start point until all labels in the index table are detected, to obtain the forward scenario list.

18. The non-transitory computer readable storage medium according to claim 16, wherein the reverse aggregating the labels in the index table in an order of positions from back to front to obtain a reverse scenario list, comprises:
executing steps of the reverse aggregation by taking a last label in the index table as a start point: acquiring a preset number of adjacent labels from the start point as a first label group, and detecting whether there is a label that has a proportion exceeding a proportion threshold in the first label group; changing, if there is the label that has the proportion exceeding the proportion threshold in the first label group, the labels in the first label group to the label that has the proportion exceeding the proportion threshold; and
continuing executing the steps of the reverse aggregation by taking a label adjacent to the first label group as a start point until a first label in the index table is detected to obtain the reverse scenario list.

19. The non-transitory computer readable storage medium according to claim 17, wherein the operations further comprise:
reducing the preset number of adjacent labels to continue executing the steps of the forward aggregation or the reverse aggregation, if there is no label that has the proportion exceeding the proportion threshold in the first label group.

20. The non-transitory computer readable storage medium according to claim 16, wherein the bidirectional aggregating the labels in the index table according to the forward scenario list obtained through the forward aggregation and the reverse scenario list obtained through the reverse aggregation, comprises:
dividing the video into at least one scenario segment; and
for each scenario segment of the at least one scenario segment, using, if a similarity between the forward scenario list and the reverse scenario list corresponding to the each scenario segment is not smaller than a preset similarity threshold, the label in the forward scenario list as a label of the each scenario segment.
